(19) United States
(12) Patent Application Publication
(10) Pub. No.: US 2012/0311947 A1
(43) Pub. Date: Dec. 13, 2012

(54) EXPANSION ANCHOR

(76) Inventor: John Van Wissen, Melbourne (AU)

(21) Appl. No.: 13/154,632

(22) Filed: Jun. 7, 2011

(51) Int. Cl. E04B 1/16; F16B 13/06

(52) U.S. Cl. 52/250; 411/55

(57) ABSTRACT

An expansion anchor 10 comprising a bolt 12 having a head 14 and a threaded stem 16. The stem 16 extends from the head 14 about a generally longitudinal axis. The anchor 10 also comprises an expansion cone 20 having a threaded bore 22, the cone 20 being threadably receivable about the threaded stem 16. The anchor 10 further comprises an expansion sleeve 24 receivable about the stem 16, with the cone 20 being receivable within the sleeve 24. The cone 20 is configured to be drawn into the sleeve 24 upon rotation of the bolt 12 about the longitudinal axis relative to the cone 20, thereby causing the sleeve 24 to expand in a radial direction relative to the longitudinal axis to bring the sleeve 24 into anchoring engagement with a surface S of a hole H into which the anchor 10 is inserted. The outer surface 23 of the cone 20 has a cone abutment surface 26. The cone abutment surface 26 is provided for abutment with a sleeve abutment surface 30 provided on an inner surface 32 of the sleeve 24 to limit movement of the cone 20 in a longitudinal direction relative to the sleeve 24.

The present invention relates broadly to the building and construction industries and, more particularly, to securing items in the building and construction industries. The invention will be hereinafter generally described in the exemplary context of anchoring or bracing upstanding pre-cast concrete panels. However, it is to be appreciated that the invention may have a range of other possible temporary and permanent applications.

Building and construction using pre-cast concrete panels often necessitates temporarily supporting panels in an upstanding orientation prior to integrating or otherwise connecting the panels into the overall structure being created. Without adequate support, upstanding concrete panels are inherently unstable and dangerous. Thus, bracing is generally required to temporarily support the panels. Bracing requires connection of one end of a brace (or brace arm) to the panel being supported in the upstanding orientation, and connection of the other end of the brace to the underlying footing, usually in the form of a concrete floor slab or temporary deadman footing. Connection of the brace to the panel is usually undertaken by way of a suitably designed bolt. Connection of the bracing to the slab generally requires a stronger connection than possible using a bolt, and so an expansion anchor or expansion bolt (hereinafter collectively referred to as an ‘expansion anchor’) is usually required. A hole must be drilled (or otherwise provided) in the floor slab for receiving the anchor. The brace, bolt and anchor are usually removed when no longer required, after which filler is used to fill the holes in the panel and floor slab.

Existing expansion anchors offer a generally suitable solution for the bracing of panels. However, the holding strength of existing anchors can be compromised if the anchor is installed incorrectly. Moreover, existing expansion anchors have an inherent design weakness, which allows the cone nut (or expansion cone) to travel an excessive axial distance into the expansion sleeve. This, in turn, adversely affects the anchor's locking depth, which undesirably reduces the sheer cone radius. The above short comings can have serious and dangerous consequences. Further, existing anchors can be prone to loosening because of cyclic loading, which obviously can also have disastrous and dangerous consequences.

It would be desirable to provide an improved expansion anchor with increased holding strength.

It would be desirable to provide an expansion anchor that limits the extent of axial travel of the expansion cone into the expansion sleeve regardless of the tightening torque applied by the installer, and regardless of the axial forces induced by loading on the anchor during use.

It would also be desirable to provide an expansion anchor that can provide a holding strength of improved consistency, generally regardless of the ability or experience of the installer or specific application.

It would also be desirable to provide an expansion anchor that is less prone to the detrimental effects of cyclic loading.

The present invention seeks to at least partially address one or more of these desirabilities.

### SUMMARY OF THE INVENTION

According to a broad aspect of the present invention, there is provided an expansion anchor. The anchor comprises a bolt having a head and a threaded stem. The stem extends from the head about a generally longitudinal axis. The anchor also comprises an expansion cone having a threaded bore, the cone being threadably receivable about the threaded stem. The anchor further comprises an expansion sleeve receivable about the stem, with the cone being receivable within the sleeve. The cone is configured to be drawn into the sleeve upon rotation of the bolt about the longitudinal axis relative to the cone, thereby causing the sleeve to expand in a radial direction relative to the longitudinal axis to bring the sleeve into anchoring engagement with a surface of a hole into which the anchor is inserted. The outer surface of the cone has a cone abutment surface. The cone abutment surface is provided for abutment with a sleeve abutment surface provided on an inner surface of the sleeve to limit movement of the cone in a longitudinal direction relative to the sleeve.

Tightening of the expansion anchor draws the expansion cone in an axial direction into the expansion sleeve. The radial forces thereby induced into the surrounding substrate causes the inner surface of the sleeve to become swaged around the outer surface of the cone.

The combination effect of the swaging, and engagement of the cone abutment surface with the sleeve abutment surface results in a solid under-cutting mass at a fixed depth within the substrate.

The load capacity of an expansion anchor is in direct proportion to its depth in the substrate. The deeper the anchor is locked within a hole provided in the substrate, the higher the pull out strength of the anchor. The greater the depth at which an anchor engages and locks into a substrate hole, the larger the shear cone. If, however, the cone is allowed to slide up into the expansion sleeve then this will adversely change the engagement depth of the expansion sleeve; with a marked decrease in the shear cone diameter and consequent decrease in pull out strength.

The present invention provides a potentially superior anchor than current designs. This is because the expansion anchor is capable of engaging the sidewall of a hole, and thereby being locked in position, at a greater depth and without the extent of pull out during service compared to that experienced with existing anchors.

In one preferred form, the cone abutment surface extends generally peripherally about the threaded bore, and the sleeve abutment surface extends generally peripherally about a sleeve bore provided in the sleeve.

In one possible form, the anchor comprises a spacer having a spacer bore, with the anchor assembled such that the stem extends through the spacer bore. The spacer is preferably mounted on the stem between a stem abutment surface and the sleeve, and is deformable in the longitudinal direction. The provision of a spacer, in effect, provides a deformation zone to allow for pull-down when tightening the bolt, so that the bolt and fixture are pulled down firmly against the underlying slab or substrate (or other footing) during anchor installation.

In one form, the spacer comprises a generally cylindrical body through which extends the spacer bore. The spacer may also comprise a flange extending about the generally cylindrical body. The flange may be divided into a plurality of flange portions. For example, the flange may include six flange portions generally equidistantly spaced about the generally cylindrical body.

The bolt preferably comprises an integrated washer. The washer may have an underside comprising a plurality of serrations thereon to, in use, resist unintentional loosening of the anchor. This may be of particular benefit in reducing the likelihood of the bolt loosening if exposed to a cyclic loading. Cyclic loading may be generated by environmental forces such as wind and/or by may be inadvertently generated by human activity.

The outer surface of the cone may adopt any suitable shape, including a frusto-conical shape. More preferably, however, the cone has a tapered outer surface, the taper varying in a direction corresponding to a bore axis extending generally longitudinally through the bore

The invention has, so far, been described generally in the context of an expansion anchor. The invention is also directed to a bracing arrangement. In the context of bracing an upstanding concrete panel, the bracing arrangement preferably comprises an expansion anchor of the type broadly described above for receiving in the first hole provided in a footing, and a second bolt for receiving in second hole provided in the upstanding concrete panel. A brace would extend between the expansion anchor and the second bolt for temporarily supporting the concrete panel in position.

### BRIEF DESCRIPTION OF THE DRAWINGS

The attached drawings show an example embodiment of the invention of the foregoing kind. The particularity of those drawings and the associated description does not supersede the generality of the preceding broad description of the invention.

FIG. 1 shows a perspective view of an expansion anchor according to one embodiment of the invention.

FIG. 2 is an exploded perspective view of the expansion anchor illustrated in FIG. 1.

FIG. 3 is an end view of the expansion anchor illustrated in FIG. 1.

FIG. 4 is another end view of the expansion anchor illustrated in FIG. 1.

FIG. 5 is a side view of the expansion anchor illustrated in FIG. 1.

FIG. 6 is a sectional side view of the expansion anchor illustrated in FIG. 1.

FIG. 7 is a perspective view of the expansion anchor illustrated in FIG. 1 in use.

FIG. 8 is a side view of the arrangement illustrated in FIG. 7.

FIG. 9 is a magnified partly sectional side view of the arrangement illustrated in FIG. 7.

FIG. 10 is a perspective view of a bolt of a bracing arrangement for use in conjunction with the expansion anchor illustrated in FIG. 1.

### DETAILED DESCRIPTION OF THE DRAWINGS

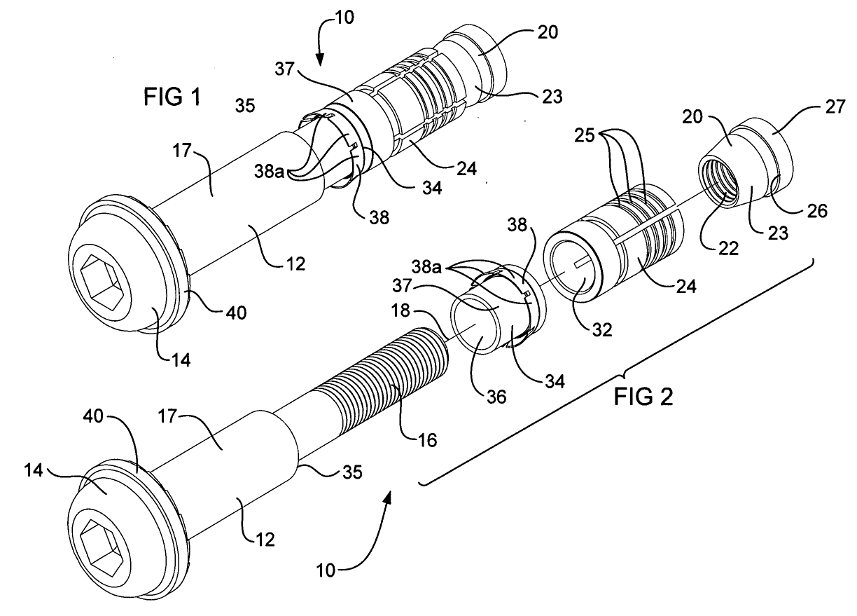

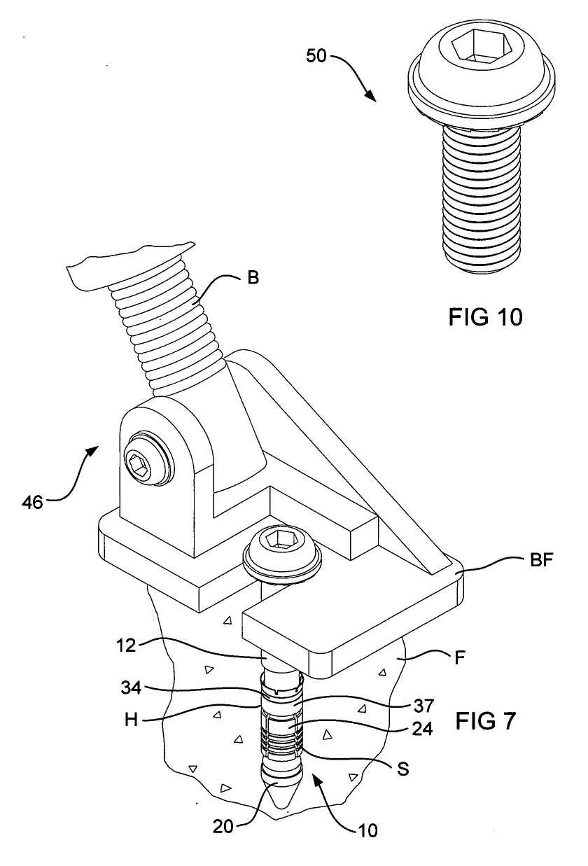

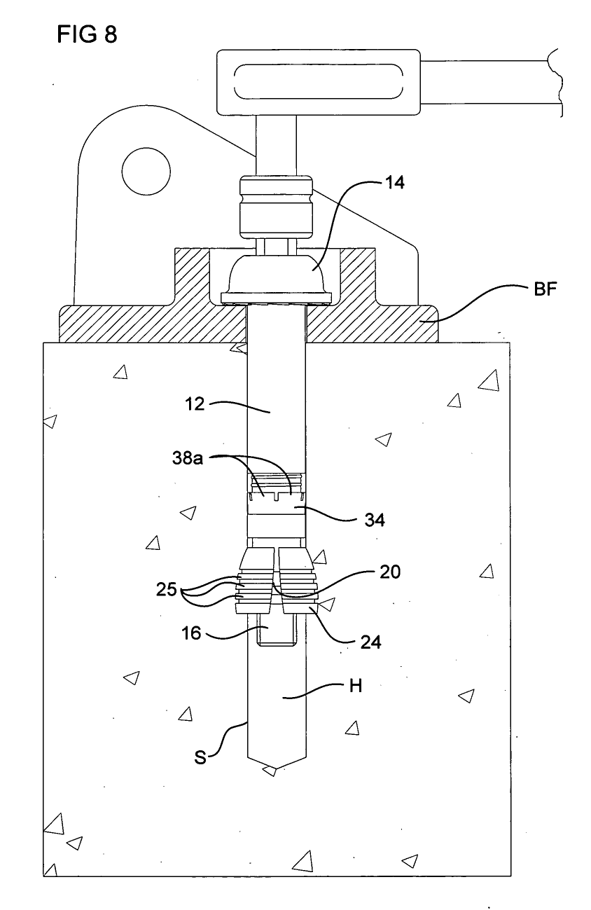

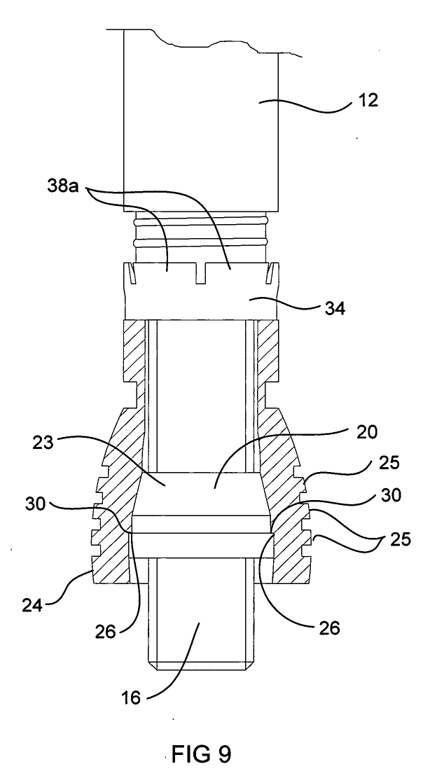

Referring to FIGS. 1 to 9, there is illustrated an expansion anchor 10. The anchor 10 is designed specifically (but not exclusively) for anchoring the foot BF of a brace B (see FIGS. 7 and 8) in place on an underlying footing F.

The anchor 10 may be used in conjunction with a wide variety of footing and panel types, comprising precast concrete, poured in situ concrete, concrete floor systems, brickwork, stonework, sandstone work, concrete block-work, roof anchors, open cut mining and the like.

The anchor 10 has been specifically designed to secure highly stressed fixtures subjected to cyclic loading.

The anchor 10 comprises several assembled components. The anchor comprises a bolt 12 having a head 14, a threaded stem 16 and a 20 mm diameter solid spigot 17.

The stem 16 has an M14 thread having a 2 mm pitch. The head 14 is a forged dome socket head configured for receiving a 14 mm hex socket (as shown in FIG. 8). The stem 16 extends from the head 14 about a generally longitudinal axis 18 (see FIG. 2).

The requirement of a 14 mm hex socket for tightening and loosening the bolt 12 has been selected on the basis that 14 mm sockets are not commonly found on building and construction sites. This lessens the likelihood of the bolt 12 being unwittingly loosened, which can result in potentially dangerous or fatal consequences.

The anchor 10 also comprises an expansion cone 20 (or cone nut) having a threaded bore 22. The cone 20 is threadably receivable about the threaded stem 16. The cone 20 has a tapered outer surface 23, the taper varying (curved) in a direction corresponding to axis 18. The curved outer surface 23 of the cone 20 (when viewed in profile) assists in engagement and interaction of the cone 20 with the inner surface of the expansion sleeve 24.

The expansion sleeve 24 is receivable about the stem 16, with the expansion cone 20 being axially receivable within the sleeve 24. During installation (when it is required to secure the anchor 10 into position within a hole H in the footing F—see FIG. 7), the cone 20 is axially drawn into the expansion sleeve 24. This occurs by rotating (ie. tightening) the bolt 12 (using a 14 mm socket) about the longitudinal axis 18 relative to the expansion cone 20.

The sleeve 24 has three ribs 25 extending peripherally about the outer surface of the sleeve 24. The ribs 25 increase the number of shear cones by a factor of three, and have the effect of distributing the axial load over a greater area along the length of the hole H. This, in turn, provides a stronger engagement between the sleeve 24 and the sidewall of the hole H.

The anchor 10 is designed as a single use item. It is not intended to be re-used, although it may be possible to re-use the bolt 12 in some applications.

Drawing the cone 20 into the expansion sleeve 24 causes the sleeve 24 to expand in a radial direction relative to the longitudinal axis 18. This, in turn, brings the sleeve 24 into anchoring engagement with the surface S of the hole H (see FIGS. 7, 8 and 9).

A cone abutment surface 26 extends peripherally about the outer surface 23 of the expansion cone 20. The cone abutment surface 26 is provided in the form of a step between the tapered surface 23 and circumferential ring 27. The cone abutment surface 26 is provided for abutment with a sleeve abutment surface 30 (shown in FIGS. 6, 8 and 9) extending peripherally about an inner surface 32 of the sleeve 24. The sleeve abutment surface 30 is in the form of an internally machined tapped step. Abutment of the cone abutment surface 26 and sleeve abutment surface 30 limits movement of the expansion cone 20 in a longitudinal direction relative to the sleeve 24. In turn, this limits the extent to which the expansion cone 20 can move axially into the sleeve 24. Once the cone abutment surface 26 and the sleeve abutment surface 30 make contact (during installation of the anchor 10), the expansion cone 20 cannot move any further into the sleeve 24. This, in turn, means that the sleeve 24 has been expanded in a radial direction to its maximum possible diameter within the hole H, and the depth of the shear cone is now fixed. Thus, interaction of the cone abutment surface 26 and sleeve abutment surface 30 provides a pre-defined endpoint to the extent of longitudinal travel of the expansion cone 20 into the expansion sleeve 24. This potentially provides an expansion anchor 10 of considerably greater holding strength than existing expansion anchors. It also potentially allows for more consistent installation of such anchors 10, thereby potentially providing a greater degree of certainty of the pull-out strength of a given anchor 10, once installed.

The anchor 10 comprises a spacer 34. The spacer 34 has a bore 36. In the assembled state, the stem 16 extends through the bore 36. The spacer 34 is mounted on the stem 16 between a stem abutment surface 35 and the sleeve 24. The spacer 34 is deformable in the longitudinal direction, thereby providing a deformation zone to allow for pull-down of the bolt 12 and brace foot BF firmly on the footing F.

The spacer 34 comprises a generally cylindrical body 37 through which extends the bore 36. The spacer 34 also comprises a flange 38 extending about the generally cylindrical body 36. The flange 38 is divided into six flange portions (or wings) 38a spaced generally equidistantly about the generally cylindrical body 36. When the anchor 10 is placed in the hole H, the flange portions 38a provide a one-way ratchet arrangement with the sidewall of the hole H. This prevents the expansion sleeve 24 from undesirably moving up the hole H once the expansion cone 23 makes contact with the expansion sleeve 24 during installation. This assists in locking the expansion sleeve 24 onto the sidewall of the hole H at the maximum possible depth.

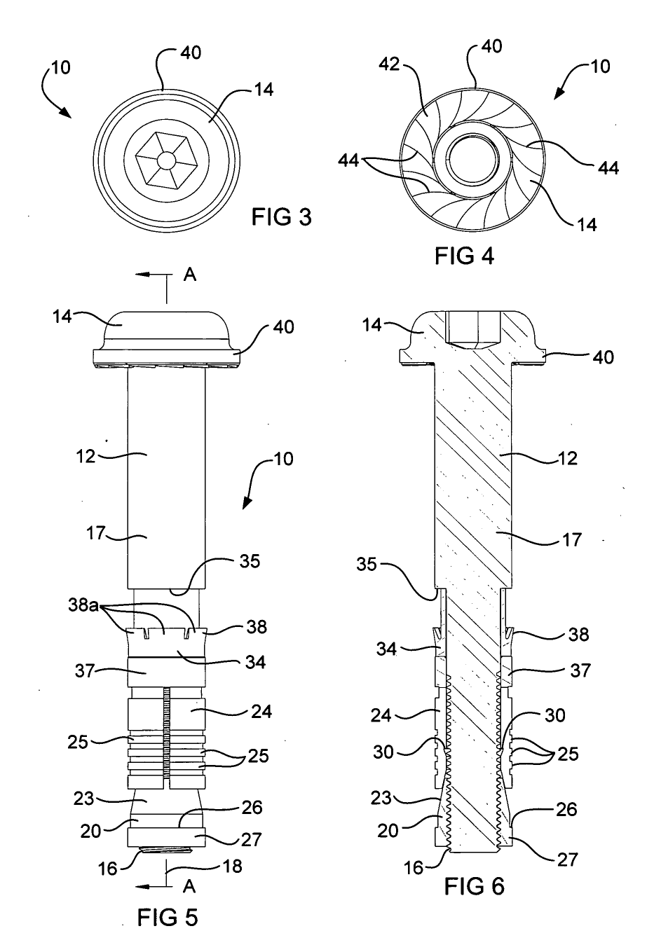

The bolt 12 comprises an integrated washer 40 having a 38 mm diameter. The washer 40 has an underside 42 comprising a plurality of serrations 44 thereon (as shown in FIG. 4). In use, the serrations 44 engage the surface of the brace footing BF to resist unintentional loosening of the anchor 10.

The invention also comprises a bracing arrangement 46. The bracing arrangement 46 is partially illustrated in FIGS. 7 and 8 in the context of supporting a pre-cast concrete panel (not shown). The bracing arrangement 46 comprises an expansion anchor 10 of the type illustrated in FIGS. 1 to 6 and 9. The anchor 10 is provided for bracing the brace foot BF provided at the lower end of the brace B. The anchor 10 is received in a pre-drilled hole H of 20 mm diameter and a minimum depth of 120 mm provided in a footing F. The anchor 10 may require hammering into the hole H, so that the washer 40 is substantially flush against the top surface of the brace footing BF. Once this is achieved, the bolt 12 can be tightened to draw the cone 20 axially into the sleeve 24 to expand the sleeve 24 radially against the sidewall of the hole H. A suitable torque for tightening the bolt 12 may be 150 Nm. The spacer 34 may be crushed or otherwise deformed during tightening of the bolt 12 to ensure pull-down of the bolt head 14 onto the brace foot BF.

The bracing arrangement 46 also comprises a brace bolt 50 (see FIG. 10). The brace bolt 50 has a head substantially identical to that of bolt 12. The brace bolt 50 is provided for receiving in a pre-drilled steel ferrule in the upstanding pre-cast concrete slab for bracing the upper end (not shown) of the brace B. Thus, the brace B is secured in position between the expansion anchor 10 and the brace bolt 50 to temporarily support the concrete panel in position.

When the bracing arrangement 46 is no longer required the bolts 12, 50 are simply undone and removed. The brace B is then removed, and the holes remaining upon removal of the bolts 12, 50 are then filled with a suitable filler.

Advantageously, the present invention has been shown to provide a potential 7 tonne pull-out strength, which far exceeds the 4 tonne pull-out strength of existing arrangements. The present invention has also been shown to be far less prone to the detrimental effects of cyclic loading than existing arrangements.

The expansion anchor of the present invention can generally provide a holding strength of improved consistency, given that the design limits the extent to which the cone is axially receivable within the expansion sleeve which, in turn, limits the extent of radial expansion of the sleeve. Thus, the invention potentially provides greater reliability and confidence that will provide a safe bracing structure up to its rated load capacity when compared to existing arrangements.

Finally, it is to be understood that the various alterations, modifications and/or additions may be introduced into the construction and arrangement of the parts previously described without departing from the spirit or ambit of this invention.

1. An expansion anchor, comprising:
a bolt having a head and a threaded stem, the stem extending from the head about a generally longitudinal axis;
an expansion sleeve receivable about the stem; and
an expansion cone having a threaded bore; the cone being threadably receivable about the threaded stem;
the cone being receivable within the sleeve; and
the outer surface of the cone having a cone abutment surface, the cone abutment surface provided for abutment with a sleeve abutment surface provided on an inner surface of the sleeve to limit movement of the cone in a longitudinal direction relative to the sleeve;
the cone being configured to be drawn into the sleeve upon rotation of the bolt about the longitudinal axis relative to the cone, thereby causing the sleeve to expand in a radial direction relative to the longitudinal axis to bring the sleeve into anchoring engagement with a surface of a hole within which the anchor is placed.

2. An expansion anchor according to claim 1, wherein the cone abutment surface extends generally peripherally about the threaded bore, and the sleeve abutment surface extends generally peripherally about a sleeve bore.

3. An expansion anchor according to claim 1, the anchor comprising a spacer having a spacer bore, the stem extending through the spacer bore, the spacer mounted on the stem between the head and the sleeve, the spacer being deformable in the longitudinal direction.

4. An expansion anchor according to claim 3, wherein the spacer is mounted between a stem abutment surface provided on the stem and the sleeve.

5. An expansion anchor according to claim 3, wherein the spacer comprises a generally cylindrical body through which extends the spacer bore.

6. An expansion anchor according to claim 5, wherein the spacer comprises a flange extending about the generally cylindrical body.

7. An expansion anchor according to claim 6, wherein the flange is divided into a plurality of flange portions.

8. An expansion anchor according to claim 7, comprising six flange portions generally equidistantly spaced about the generally cylindrical body.

9. An expansion anchor according to claim 1, wherein the head comprises an integrated washer.

10. An expansion anchor according to claim 9, the washer having an underside comprising a plurality of serrations thereon to, in use, resist unintentional loosening of the anchor.

11. An expansion anchor according to claim 1, the head configured for receiving a hex 14 mm socket.

12. An expansion anchor according to claim 1, wherein the cone has a tapered outer surface, the taper varying in a direction corresponding to a bore axis extending generally longitudinally through the bore.

13. An expansion anchor according to claim 4, the bolt comprising a solid shaft of approximately 20 mm diameter extending between the stem abutment surface and the head.

14. A bracing arrangement comprising:
an expansion anchor according to claim 1 for receiving in the first hole provided in a footing, and
a second bolt for receiving in second hole provided in an upstanding concrete panel.

15. A bracing arrangement according to claim 14, comprising a brace for mounting to the footing with the anchor, and to the panel with the second bolt.

16. A bracing arrangement according to claim 14, wherein, in use, the cone abutment surface and sleeve abutment surface interact to prevent further longitudinal movement of the expansion cone into the expansion sleeve beyond a pre-defined end point.
